(19) United States
(12) Patent Application Publication
(10) Pub. No.: US 2026/0326903 A1
(43) Pub. Date: Oct. 22, 2026

(54) AIRCRAFT PROPULSION SYSTEM AND AN AIRCRAFT

(71) Applicant: Airbus Operations SAS, TOULOUSE (FR)

(72) Inventors: Pierre-Antoine COMBES, TOULOUSE (FR); Nicolas JOLIVET, TOULOUSE (FR); Fabrice GRIMAL, TOULOUSE (FR); Marc DE NICOLA, TOULOUSE (FR); Olivier PAUTIS, TOULOUSE (FR)

(21) Appl. No.: 19/649,598

(22) Filed: Apr. 16, 2026

Related U.S. Application Data
(60) Provisional application No. 63/790,501, filed on Apr. 17, 2025.

(51) Int. Cl. B64D 27/40; B64D 29/02

(52) U.S. Cl. CPC B64D 27/402; B64D 27/404; B64D 27/406; B64D 29/02

(57) ABSTRACT

A mounting assembly for securing an aircraft engine to a wing via a pylon. The mounting assembly including a front engine mount with two rods extending between front engine lugs and a pylon yoke and two shackles extending between pylon lugs and engine lugs. The components may be doubled. Also an aircraft with such a mounting assembly.

### CROSS-REFERENCE TO RELATED APPLICATIONS

This application which claims the benefit of U.S. Pat. Application Ser. No. 63/790,501, filed on Apr. 17, 2025, the entire disclosures of which are incorporated herein by way of reference.

### FIELD OF THE INVENTION

The present invention relates to an aircraft propulsion system and an aircraft with a propulsion system, and in particular wherein the propulsion system includes a turbojet engine and attachment means for securing the turbojet engine to the aircraft.

### BACKGROUND OF THE INVENTION

An aircraft conventionally has a plurality of propulsion systems. Each propulsion system is generally secured underneath a wing of the aircraft and includes a powerplant, for example, a turbojet engine, secured under the wing and attachment means for securing the turbojet engine under the wing.

Although current propulsion systems are satisfactory and meet the necessary requirements, the assembly and disassembly of the attachment means or mounting assemblies which connect a pylon and an engine are generally lengthy and complex. There is an ongoing need and desire to provide to mounting assemblies that reduces installation time and complexity while meeting the necessary requirements.

### SUMMARY OF THE INVENTION

New engine mounting assemblies have been invented. The new engine mounting assemblies do not generate major aero hard-points for external aerodynamic lines. Additionally, in the new engine mounting assemblies, failsafe scenarios are fully considered. Further, the engine mounting assemblies architecture is defined so that the loads at each interface are reasonable and well distributed between each interface. In addition to meeting the foregoing requirements, in the new engine mounting assemblies, the engine to pylon interfaces provide an easy/simple accessibility for engine installation/removability.

According to one or more aspects, the present invention may be characterized as providing a mounting assembly for securing an aircraft engine to a wing via a pylon, the mounting assembly comprising: a front engine mount disposed between the aircraft engine and the pylon, the front engine mount including: two front rods extending between front engine lugs of the aircraft engine and a pylon yoke of the pylon; and two front shackles extending between pylon lugs of the pylon and middle engine lugs of the aircraft engine, wherein the two front rods and the two front shackles cooperatively transfers loads in six degrees of freedom of the aircraft engine relative to the pylon.

The front engine mount may define an isostatic mounting system that transfers loads in exactly six degrees of freedom and balances engine loads and moments.

The front engine mount may define a dual load path such that loads along X, Y, and Z axes are transmitted through two distinct structural paths.

The two front rods may be arranged in pairs and may be configured to transfer translational loads along X, Y, and Z axes and to balance bending moments about at least Y and Z axes.

The two front shackles may be disposed within a volume of a front rib of a pylon box. The two front shackles may be oriented in an XZ‑plane, and have a load projection in a Z direction such that the two front shackles balance engine torque about an X axis. Each of the two front shackles may have an axis extending through lateral panels of the a front rib of the pylon such that loads are transferred in shear and bending moments are reduced.

Each interface of the front engine mount may be doubled to provide fail‑safe capability. The doubled interfaces may include front engine lugs, front rods, and rod axes. The doubled interfaces may include middle engine lugs, shackles, shackle axes, and pylon lugs.

The front engine mount may be configured to be contained within nacelle aerodynamic lines so as to reduce aerodynamic drag.

According to one or more aspects, the present invention may also be characterized as providing an aircraft, comprising: a wing; an aircraft engine; a pylon secured to the wing; and a mounting assembly as described herein securing the aircraft engine to the pylon.

These and other aspects and embodiments of the present invention, any of which may be combined in any manner with any other aspect, embodiment or configuration, will be appreciated by those of ordinary skill in the art based upon the following description of the drawings and detailed description.

### BRIEF DESCRIPTION OF THE DRAWINGS

The characteristics of the invention will emerge more clearly from a reading of the following description of at least one example of embodiment, said description being produced with reference to the accompanying drawings, among which:

FIG. 1 is a side view of an aircraft comprising an assembly according to the invention;

FIG. 2 is a side view of an assembly according to the invention;

FIG. 3A is a schematic representation of conventional structure with single load paths;

FIG. 3B is a schematic representation of structure with dual load paths;

FIG. 4 is a side view of an assembly according to the invention showing loads taken up by the components of the assembly;

FIG. 5 is a close-up view of the front engine mount of an assembly according to the invention;

FIG. 6 is another side view of an assembly according to the invention; and,

FIG. 7 is a further side view of an assembly according to the invention.

In general, the same reference numbers will be used throughout the drawing(s) and accompanying written description to refer to the same or like parts.

### DETAILED DESCRIPTION

As mentioned above, new engine mounting assemblies have been invented.

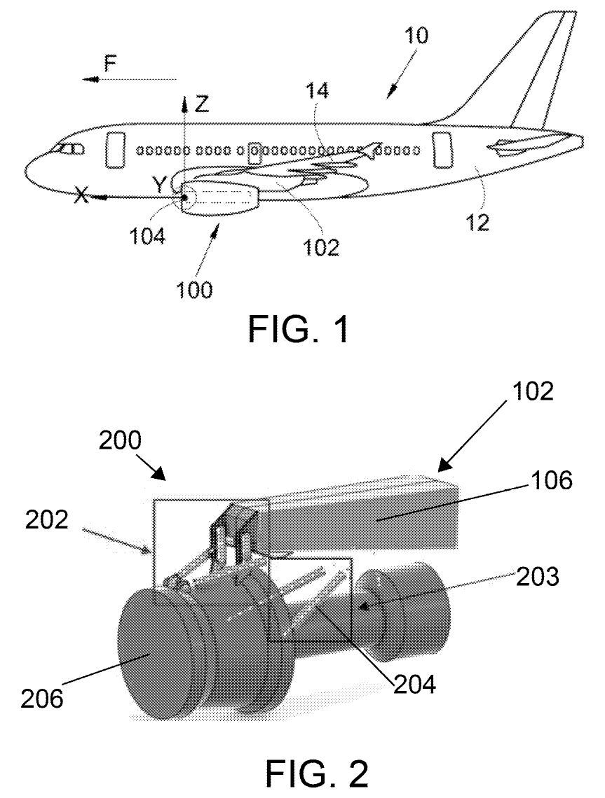

FIG. 1 shows an aircraft 10 which has a propulsion system 100. The aircraft 10 has, on both sides of a fuselage 12, a wing 14 to which an engine pylon 102 is fixed. The propulsion system 100 generally includes the engine pylon 102 and an engine 104.

In the following description, and by convention, X is called the longitudinal axis of the engine oriented positively in the direction of advance of the aircraft 10, it is called Y, the transverse axis of the engine which is horizontal when the aircraft is on the ground, and Z, the vertical axis or vertical height when the aircraft is on the ground, these three axes X, Y and Z being mutually orthogonal. The fore and aft positions are taken in relation to the forward and aft of the aircraft 10. The direction of advancement of aircraft 10 is given by the arrow F which shows the direction in which aircraft 10 advances when engines 104 are running. The engine 104 has a vertical median plane P (XZ).

In the frame of the aircraft engine 104 with high loads to be transferred from the engine 104 to the wing 14, there are specific requirements for engine mounts systems between the pylon 102 and the engine 104.

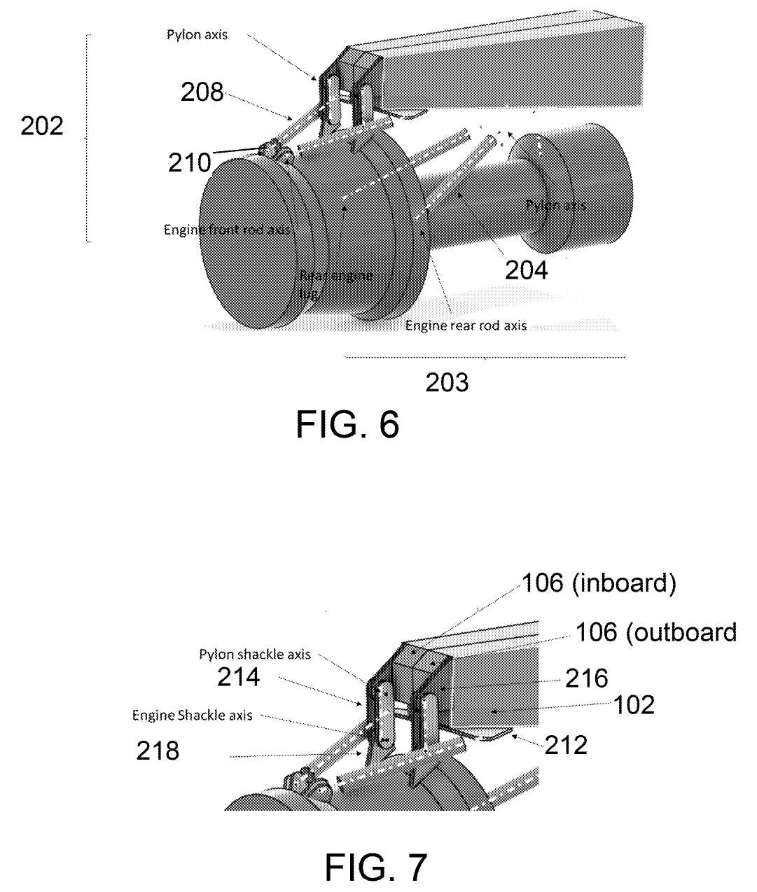

The new engine mounting assemblies 200 are shown FIGS. 2 and 4-7 with front engine mounts 202. The new engine mounting assemblies 200 also include rear engine mounts 203 with rear rods 204 connecting the core of the engine 104 to the pylon 102.

The front engine mounts 202 are disposed above the fan casing 206 of the engine 104, and utilize using various mechanical attachment structures (rods, mechanical parts, etc.). In general, the arrangement of mechanical parts between the pylon 102 and engine 104 can be: in a deterministic manner (6 Degrees of Freedom); in a deterministic manner (6 Degrees of Freedom) with a waiting failsafe interface; or in a statically undetermined manner (more than 6 Degrees of Freedom) (hyperstatism). In the presently depicted embodiment, the embodiment is a dual load path with a waiting out a failsafe.

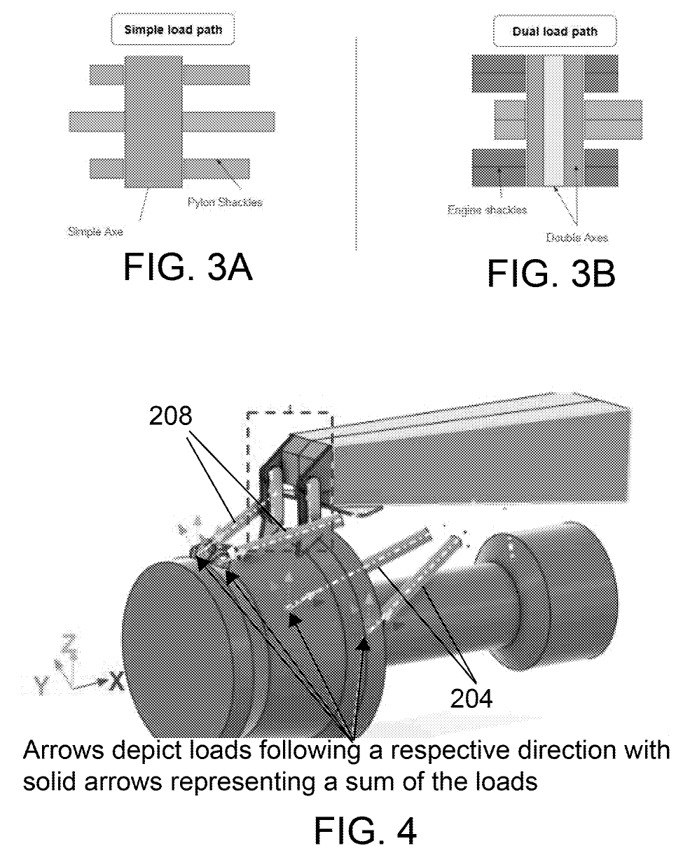

As may be used herein, a “dual load path” refers to a structure that is fail safe when it is damage tolerant: in case of failure or rupture (total or partial) of one of its components, it can continue to ensure its functions, at least up to the next inspection control. To continue performing these functions, the constituent elements are doubled. The two-part main support allows the transmission of loads along the X, Y and Z axes via two different paths. This design does not introduce any moment into the front support or into the forward mount. A conventional structure is shown in FIG. 3A and an example dual load path structure is depicted in FIG. 3B.

As can be seen in FIG. 4, the present embodiment of the invention includes two sets of rods 204, 208 to ensure a widespread attachment to the engine 104, thus making the best of the available wheelbases between engine strong frames. Working in a pair, these rods 204, 208 with a XYZ-projection help transferring all loads (TX, TY and TZ) and balancing moments (especially MY and MZ). As shown in FIG. 4, the color of the arrows reflects the direction in which the loads are flowing in the depicted embodiment.

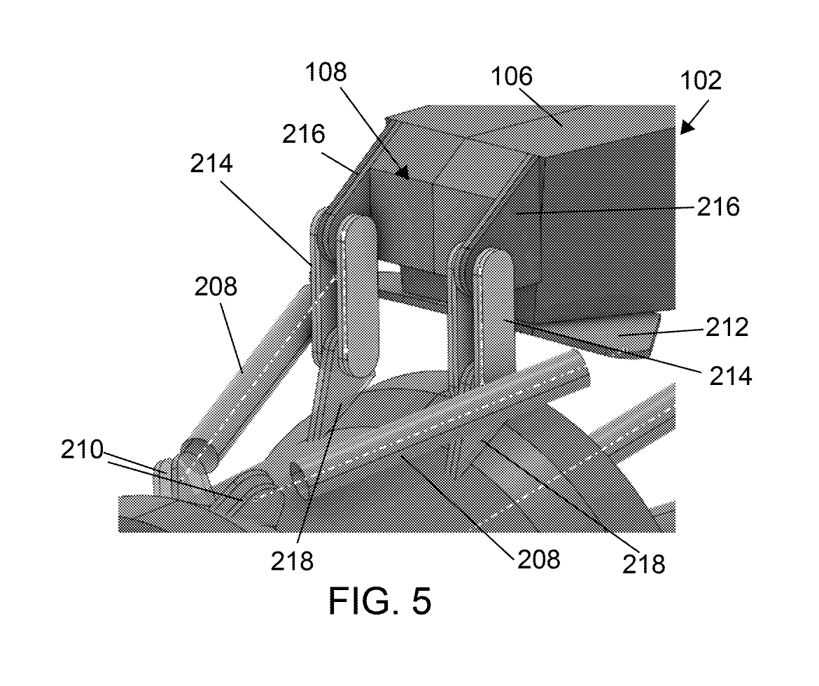

Turning to FIGS. 5-7, the front rods 208 extend between front engine lugs 210 and a yoke 212 on the pylon 102. Ball bearings (not shown) may be present at each end of the rods 204, 208.

The front engine mounts 202 also includes front shackles 214 with interfaces distributed within the volume of the front rib 106 (called N1) of the pylon box 108. The front shackles 214 extend between pylon lugs 216 and mid engine lugs 218. The compact design optimizes the aerodynamic integration of the area, which is very sensitive because it is blown by the fan jet and close to the propeller of the engine 104.

The load inputs are aligned with the main webs of the structural partitions constituting the pylon box 108: the vertical shackles 214 borne by the lateral panels of the front rib 106 are contained in a XZ-plane. Their projection is in a pure Z-direction (vertical) so that they ensure the balancing of the MX (Engine Torque).

The axis of the shackles 214 goes through the lateral panels and the strong rib 106, thus loading both parts in shear and preventing the introduction of additional moments in the pylon box 108.

The system 200 depicted in the present embodiment is statically determinate, which means that all interfaces are required to maintain the 6 DoFs. The failure of one of the interfaces would not guarantee the connection of the engine 104 to the pylon 102. It is therefore mandatory to render all interfaces fail safe.

In order to preserve the geometry of the new engine mounting assemblies 200 therefore the load levels, for the fail-safe scenarios, it is considered that all interfaces are doubled (shackles 214, front and rear rods 208, 204, lugs 210, 216, 218 and pins). Specifically, in the present embodiment, the following elements are doubled:

Front rods: front engine lug 210, front engine rod axis, front rod 208, pylon axis;

Rear rods: rear engine lug, engine rear rod axis, rear rod 204, pylon axis; and,

Shackles: middle engine lug 218, engine shackle axis, shackle 214, pylon shackle axis, beam with lug/yoke 212, pylon lugs 216, front rib 106 (inboard and outboard).

The depicted embodiment is an isostatic mounting system. This means that the interfaces block exactly 6-Degrees of Freedom (DoF) and balance all moments (MX, MY and MZ). This depicted embodiment is intended for a “Fan Pylon” configuration and is a compact solution capable of balancing the engine torque (MX) at the forward-end of the pylon. The compact aspect of the depicted embodiment mitigates potential impacts on external aerodynamic lines and associated drag penalties. The several rods ensure the transfer of loads while being contained within the nacelle lines. The depicted embodiment enables an efficient integration of the power plant system from both an A/C and engine standpoint.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A mounting assembly for securing an aircraft engine to a wing via a pylon, the mounting assembly comprising:
a front engine mount disposed between the aircraft engine and the pylon, the front engine mount including:
two front rods extending between front engine lugs of the aircraft engine and a pylon yoke of the pylon; and
two front shackles extending between pylon lugs of the pylon and middle engine lugs of the aircraft engine,
wherein the two front rods and the two front shackles cooperatively transfers loads in six degrees of freedom of the aircraft engine relative to the pylon.

2. The mounting assembly of claim 1, wherein the front engine mount defines an isostatic mounting system that transfers loads in exactly six degrees of freedom and balances engine loads and moments.

3. The mounting assembly of claim 1, wherein the front engine mount defines a dual load path such that loads along X, Y, and Z axes are transmitted through two distinct structural paths.

4. The mounting assembly of claim 1, wherein the two front rods are arranged in pairs and are configured to transfer translational loads along X, Y, and Z axes and to balance bending moments about at least Y and Z axes.

5. The mounting assembly of claim 1, wherein the two front shackles are disposed within a volume of a front rib of a pylon box.

6. The mounting assembly of claim 5, wherein the two front shackles:
are oriented in an XZ‑plane, and
have a load projection in a Z direction such that the two front shackles balance engine torque about an X axis.

7. The mounting assembly of claim 5, wherein each of the two front shackles has an axis extending through lateral panels of the a front rib of the pylon such that loads are transferred in shear and bending moments are reduced.

8. The mounting assembly of claim 1, wherein each interface of the front engine mount is doubled to provide fail‑safe capability.

9. The mounting assembly of claim 8, wherein the doubled interfaces include front engine lugs, front rods, and rod axes.

10. The mounting assembly of claim 8, wherein the doubled interfaces include middle engine lugs, shackles, shackle axes, and pylon lugs.

11. The mounting assembly of claim 1, wherein the front engine mount is configured to be contained within nacelle aerodynamic lines so as to reduce aerodynamic drag.

12. An aircraft, comprising:
a wing;
an aircraft engine;
a pylon secured to the wing; and
the mounting assembly of claim 1 securing the aircraft engine to the pylon.
